(19) United States
(12) Patent Application Publication
(10) Pub. No.: US 2009/0089448 A1
(43) Pub. Date: Apr. 2, 2009

(54) MOBILE BROWSER WITH ZOOM OPERATIONS USING PROGRESSIVE IMAGE DOWNLOAD

(76) Inventors: David Sze, Kitchener (CA); Paul Ferraro, Seattle, WA (US)

Correspondence Address: ECKERT SEAMANS CHERIN & MELLOTT, 600 GRANT STREET, 44TH FLOOR, PITTSBURGH, PA, 15219, US

(21) Appl. No.: 12/236,994

(22) Filed: Sep. 24, 2008

Related U.S. Application Data
(60) Provisional application No. 60/976,025, filed on Sep. 28, 2007.

(51) Int. Cl. G06F 15/16

(52) U.S. Cl. 709/231

(57) ABSTRACT

A method and mobile device for providing fast rendering of a web page and zoom capability using progressive image download. A data server requests the web page and converts images within the webpage into a progressive format before forwarding the web page data to the mobile device. The initial fully zoomed-out view of the web page is rendered using initial low resolution image data first received at the device. As additional progressive resolution data is received, the device is capable of zooming in to portions of the web page using the higher resolution data. If interpolations are used in rendering an image at a particular zoom level, then the image is repainted in higher resolution as additional progressive resolution data is received.

### CROSS-REFERENCE TO RELATED APPLICATIONS

The present application claims priority to U.S. provisional patent application Ser. No. 60/976,025 filed Sep. 28, 2007.

### FIELD

The present application relates to methods, systems, and devices for facilitating mobile multimedia browsing on a client device and, in particular, mobile web browsing with zoom operations that use progressive image downloading.

### BACKGROUND

A conventional web browser, whether mobile or desktop, requests multimedia pages, i.e. web pages, from a web server over a data connection. The data connection may be wired or wireless. The web page may be made up of a number of multimedia objects, including text, animations, images, tables, and the like. The web browser typically requests the multimedia objects and other data for the web page in the order specified by the web page creator. In some instances, the web browser can begin laying out the web page and displaying objects as they are received. As such, large objects, such as images or animations, can block the retrieval of subsequent objects, resulting in a long delay before the web page is completely loaded, especially over relatively slow data connections. Accordingly, this presents a challenge to client devices that have a relatively slow data connection, such as mobile devices.

In the case of a browser displaying conventional images, the image space is typically defined in full size and as the image data is received the image is rendered in a top-down gradual filling-in operation. GIF, PNG, and JPEG image formats all also support interlaced/progressive rendering, where the full size overall image is rendered in a coarse or blocky format and is gradually improved as more data is received. GIF typically uses a one-dimensional interlaced rendering scheme, PNG typically uses a two-dimensional interlaced rendering scheme, and JPEG typically uses a quality-based progression scheme. In all these cases, the rendering of the full size image is started before all the image data is received and the displayed image is gradually improved. In some of the interlaced/progressive schemes, this can have the disadvantage that the user is unaware of when the image is complete. Also, interlaced/progressive schemes do not improve the load time of the web page in a conventional browser because the entire image must be received before the browser can move onto retrieval of the next object. These interlaced/progressive schemes are designed to improve the perceived load time of the individual objects, rather than the entire page.

One solution that has been proposed to improve web page display speed is to create a thumbnail of the overall web page at the server and send the thumbnail to the client device first, thereby enabling the client device to initially display a shrunken image of the webpage. The user sees at least a small version of the webpage before either choosing areas of interest to download, or waiting for it to fully load automatically. A drawback to the use of page thumbnails is that this is yet one more object to download and many carriers that support mobile device connectivity charge users for the quantity of data downloaded. Another drawback is that the thumbnail typically does not have the functionality of the actual web page. The user must wait until the full page is downloaded before he or she is able to interact with it by, for example, clicking on links or viewing animations or other active media.

Accordingly, it would be advantageous to improve existing methods and systems for browsing multimedia documents, such as web pages. In particular, it would be advantageous to improve the download speed for faster web browsing. It would also be advantageous to avoid excessive or extra data downloading and the associated costs.

### BRIEF DESCRIPTION OF THE DRAWINGS

Reference will now be made, by way of example, to the accompanying drawings which show example embodiments of the present application, and in which:

FIG. 1 shows an example system for facilitating zoom operations using progressive downloading;

FIG. 2 diagrammatically shows an example of an HTTP bitstream employing progressive resolution image downloading;

FIG. 3 shows, in flowchart form, an example method of displaying multimedia data on a browser;

FIG. 4 shows a second example method of displaying multimedia data on a browser; and

FIG. 5 shows a block diagram of an example embodiment of a client device.

Similar reference numerals may have been used in different figures to denote similar components.

### DESCRIPTION OF EXAMPLE EMBODIMENTS

In one aspect, the present application describes a method of performing zoom operations in a browser application on a client device, wherein the client device is configured to request a web page from a data server, and wherein the data server obtains the web page and converts images within the web page to a progressive format, the browser application being configured to offer at least three zoom levels, and wherein the at least three zoom levels include a fully zoomed-out level and an intermediate level. The method includes receiving a first portion of a response message from the server containing non-progressive data including mark-up language data and containing initial low resolution image data for each of the images; rendering the web page at the fully zoomed-out level by applying a maximum scaling factor to the web page and using the non-progressive data and the initial low resolution image data to render the web page; receiving a zoom command, wherein the zoom command defines a zoom window within the web page, the zoom window containing at least a portion of at least one image; receiving additional progressive resolution image data for the at least one image from the server after the first portion; and rendering the web page at the intermediate level by applying a intermediate scaling factor to the web page and using the non-progressive data and the combination of the initial low resolution image data and the additional progressive resolution image data. The rendering of the web page at the fully zoomed-out level is initiated before receiving additional progressive resolution image data.

In another aspect, the present application describes a mobile device configured for wireless communications with a wireless network, wherein the wireless network is connected to a data server configured to obtain a web page and to convert images within the web page to a progressive format. The mobile device includes a display screen; a communications subsystem for sending and receiving messages over a wireless link to the wireless network; a memory; a processor configured to control the communications subsystem and the display screen; a browser application configured to offer at least three zoom levels in display of the web page on the display screen, and wherein the at least three zoom levels include a fully zoomed-out level and an intermediate level; a zoom handler configured to receive a zoom command, wherein the zoom command defines a zoom window within the web page, the zoom window containing at least a portion of at least one image; and a progressive resolution image handler configured to receive a first portion of a response message from the data server containing non-progressive data including mark-up language data and containing initial low resolution image data for each of the images, and to receive additional progressive resolution image data for the at least one image from the data server after the first portion. The browser application is configured to render the web page at the fully zoomed-out level, before receiving additional progressive resolution image data, by applying a maximum scaling factor to the web page and using the non-progressive data and the initial low resolution image data to render the web page. The browser application is configured to render the web page at the intermediate level by applying a intermediate scaling factor to the web page and using the non-progressive data and the combination of the initial low resolution image data and the additional progressive resolution image data.

In yet another aspect, the present application describes a client device configured for communications with a network, wherein the network is connected to a data server configured to obtain a web page and to convert images within the web page to a progressive format. The client device includes display means for displaying the web page; communications means for sending and receiving messages over the network; memory means for storing data; processing means for controlling the communications means and the display means; browser means for offering at least three zoom levels in display of the web page on the display means, and wherein the at least three zoom levels include a fully zoomed-out level and an intermediate level; zoom means configured to receive a zoom command, wherein the zoom command defines a zoom window within the web page, the zoom window containing at least a portion of at least one image; image handling means for receiving a first portion of a response message from the data server containing non-progressive data including mark-up language data and containing initial low resolution image data for each of the images, and for receiving additional progressive resolution image data for the at least one image from the data server after the first portion; means for rendering the web page at the fully zoomed-out level, before receiving additional progressive resolution image data, by applying a maximum scaling factor to the web page and using the non-progressive data and the initial low resolution image data to render the web page; and means for rendering the web page at the intermediate level by applying a intermediate scaling factor to the web page and using the non-progressive data and the combination of the initial low resolution image data and the additional progressive resolution image data.

In another aspect, the present application describes a method and mobile device in which a browser performs a fast rendering of a web page at a fully zoomed-out scale using an initial portion of image data received in a progressive resolution image data stream, wherein the initial portion of image data includes image data having a resolution sufficient to realize the fully zoomed-out scale, and wherein the browser is configured to permit zoom operations after further image data is received in the progressive resolution image data stream so as to enable higher resolution image rendering at a higher zoom level.

Embodiments of the present application are not limited to any particular operating system, mobile device architecture, server architecture, or computer programming language. Many of the example embodiments described herein relate to mobile devices; however, it will be appreciated that the present application is not limited to mobile devices.

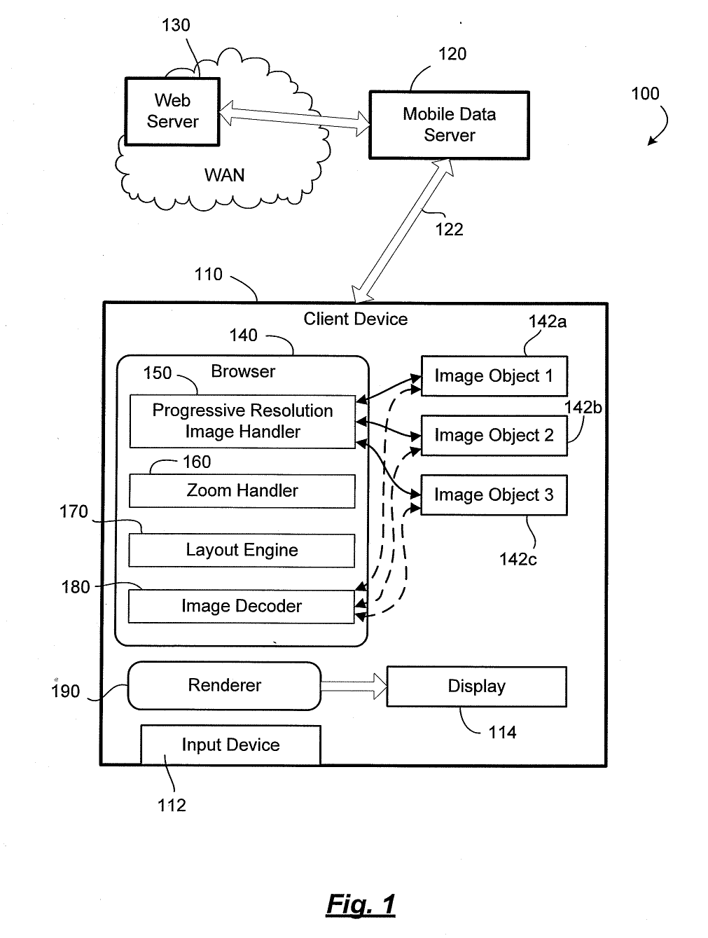

Referring now to the drawings, FIG. 1 shows an example system 100 for facilitating zoom operations using progressive downloading. The system 100 includes a client device 110 with a data connection 122 to a mobile data server 120. The mobile data server 120 is connected to a wide area network (WAN), such as the Internet, through which it may send requests and receive responses from a web server 130.

The data connection 122 may be any type of connection sufficient to support communication between the mobile data server 120 and the client device 110. In one embodiment, the data connection 122 supports a hyper-text transfer protocol (HTTP) connection between the mobile data server 120 and the client device 110. In an embodiment in which the client device 110 is a mobile wireless device, the data connection 122 may be at least partly a wireless connection. In some embodiments the wireless connection may be via WLAN, for example a WiFi connection in accordance with IEEE 802.11 protocols. In some other embodiments, the wireless connection may be over a cellular connection established using any one of a number of cellular protocols, such as GSM, GPRS, CDMA, EDGE, UMTS, EvDO, HSPDA, WiMAX, or a variety of others.

The client device 110 includes a display 114, a user input device 112, and a browser 140. The input device 112 may be any suitable input device including a mouse, trackball, trackwheel, touchpad, touchscreen, stylus, and the like. The browser 140 may include a variety of components or modules, including a progressive resolution image handler 150, a zoom handler 160, a layout engine 170, and an image decoder 180. The client device 110 may further include a renderer 190, or graphics engine, for receiving image data or instructions and controlling the display 114. Although not illustrated, it will be appreciated that the client device 110 includes one or more processors, memory, and other such elements.

The mobile data server 120 acts as a type of “proxy” server for the client device 110 in that it receives web page requests, typically via HTTP, retrieves the requested content from the web server 130, and delivers the content to the client device 110. The mobile data server 120 employs a progressive resolution download protocol (PRDP) for delivering image content to the client device 110 in response to a web page request. The PRDP is a process for sending smaller scale versions of images in the requested web page as a part of the initial HTTP response stream, and sending additional “chunks” of image data as later components of the HTTP response stream to enable the rendering of progressively larger versions of the image on the client device, if required. The PRDP will be described in greater detail below.

The progressive resolution image handler 150 manages the creation of an image object 142 (illustrated separately as 142a, 142b, 142c) for each image in the requested web page. The image objects 142 are created based on metadata received for each image and are populated with the image data for the initial scaled-down low resolution version of the image. As additional chunks of image data are received, the data is added to the image object 142.

The layout engine 170 and image decoder 180 manage the processing of mark-up language data, such as HTML, CSS, and JavaScript, and the processing of image data, respectively. The layout engine 170 and image decoder 180 supply output data to the renderer 190 for generating the web page on the display 114.

The downloading of the initial low-resolution images and the layout and mark-up language data for the web page allows the client device 110 to render an initial zoomed out, scaled-down, version of the webpage. This initial zoomed-out version of the web page is rendered relatively quickly because the client device 110 need not wait until all image data is received, only the initial low resolution scaled-down images.

The zoom handler 160 implements a zoom operation within the browser interface. When the user views a web page on the display 114, the user may manipulate the input device 112 to control a pointer, or other visual indicator of coordinates on the screen. Using the input device 112, the user may input a command to zoom in (enlarge) or zoom out (shrink). When zooming in, the position of the pointer indicates the coordinates of the web page to which the zoom command applies. In other words, the coordinates define the location of a zoom window, such as its center point, and the zoom window is that portion of the web page that is to be enlarged and displayed on the screen. In another embodiment, the input device 112 may comprise a touchscreen device, in which case the zoom window may be defined by the user by selecting a centerpoint or, in some cases, by selecting sidepoints or cornerpoints. Other mechanisms for receiving a user input providing a zoom instruction and one or more zoom coordinates will be understood by those ordinarily skilled in the art.

Advantageously, the progressive resolution delivery of image data facilitates the quick initial display of the web page in a zoomed out mode, and the smooth subsequent display of higher resolution data in a zooming in operation.

Although the embodiment illustrated in FIG. 1 shows a custom browser 140 capable of handling progressive resolution image data, in some instances the browser 140 may be a conventional web browser and the handling of progressive resolution data may be implemented by way of a browser plug-in and a client-side proxy, as detailed in U.S. patent application Ser. No. 11/535,765, owned in common herewith and entitled “System and Method for Progressive Delivery of Multimedia Objects”, the entire contents of which is hereby incorporated by reference.

It will be appreciated that the relationship or division between various components and modules, such as the image decoder 180, the progressive image handler 150, the renderer 190, the browser 140, and others, are for illustrative purposes only. In other embodiments several of the components or modules may be implemented in a different manner yet realize the same functionality described below. The implementation of various of the functions in separate modules or as part of a larger application or module is a software programming design decision within the capabilities of a person of ordinary skill in the art in computer programming, in light of the description herein.

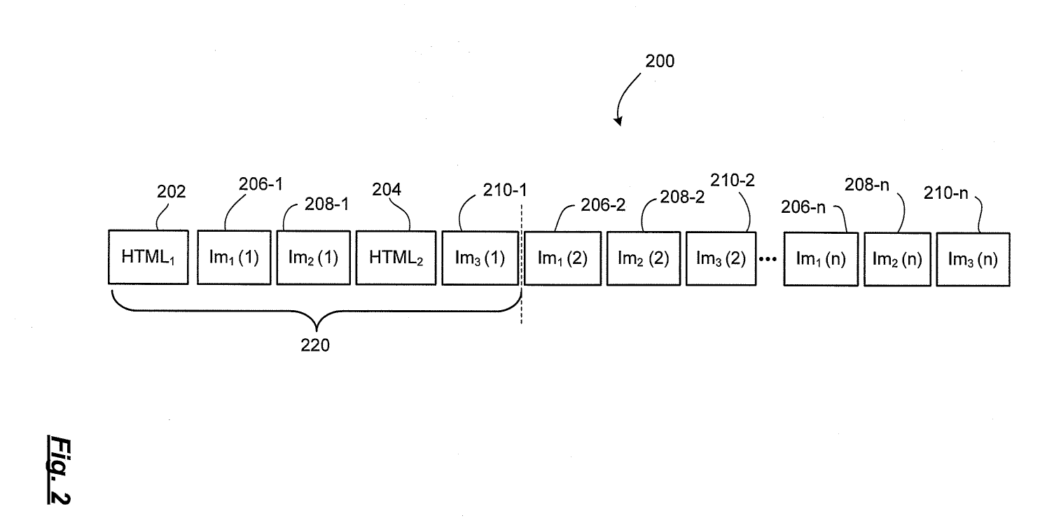

Reference is now also made to FIG. 2, which diagrammatically shows an example of an HTTP bitstream 200 employing progressive resolution image downloading.

The example HTTP bitstream 200 is an HTTP response (or stream of several responses) to an HTTP request (or requests) for a web page. The HTTP bistream 200 is generated at the mobile data server 120 (FIG. 1) based on the conventional HTTP data received by the mobile data server 120 from the web server 130. The mobile data server 120 generates the HTTP bitstream 200 by first converting the image data received from the web server 130 into a suitable progressive resolution format. A progressive resolution image format is one in which the image can be defined in a series of data segments, beginning with data defining a lowest resolution/dimensions version of the image. Each successive segment of data, when added to the previous segments, results in data that defines a progressively higher resolution (larger dimensions) image. All the data segments together define the full resolution image. A progressive resolution image format is one in which the sum of the data segments is no larger than the non-progressive image of identical dimensions and quality. In other words, segmentation of the data does not add overhead. The format may be lossless, lossy, interlaced, etc.

In one embodiment, the progressive resolution format comprises JPEG 2000, an image encoding protocol promulgated by the Joint Photographic Experts Group and partly defined by the International Standards Organization family of ISO/IEC 15444 protocols. In other embodiments, other progressive resolution image encoding protocols may be used.

Progressive resolution encoding of an image allows the image to be fully defined in a series of “chunks” of data, where each “next” chunk in the series can be combined with the previous chunks to create a better resolution or larger image. The number of resolution levels, or “chunks” of data, may be configurable. All of the “chunks” together defined the full resolution or full size image. Accordingly, the initial chunk of image data can be decoded in accordance with the imaging protocol to generate a scaled-down image. If the data from the next “chunk” is added, then the total data can be decoded in accordance with the imaging protocol to generate a larger image, but still smaller than the full image. As portions or “chunks” of the image data are appended, a progressively larger version of the image may be generated.

Referring still to FIG. 2, the example HTTP stream 200 includes a first section 220 that contains HTML data, HTML₁ 202 and HTML₂ 204. The non-progressive portions of the web page, like the HTML data 202, 204, and other non-progressive elements, are placed within the first section 220. Also within the first section 220 are the lowest resolution “chunks” of image data for each of the converted progressive resolution images. In particular, in this example embodiment, there are three images: Im₁, Im₂, and Im₃. Each of the images is converted to JPEG 2000 format, such that each one has n portions or segments of data. For each image, an initial segment of image data is formed containing the first portion of image data defining the lowest resolution data, plus metadata regarding the image. The metadata may be placed in a header or elsewhere in the segment. For example, the initial segment 206-1 for image Im₁ contains metadata and the image data defining the lowest resolution version of the image. Initial segments 206-1, 208-1, and 210-1 for the three images are shown in the first portion 220 of the HTTP bitstream 200. Accordingly, following receipt of the first portion 220 of the HTTP bitstream 200, the client device 110 (FIG. 1) is capable of rendering the web page based on the HTML data 202, 204, any other style sheet or layout data (not shown) or other non-progressive data included in the first portion 220, and the low resolution image data contained in the initial segments 206-1, 208-1, 210-1.

In some embodiments, the remaining “chunks” or segments of image data are appended to the first portion 220 as the remainder of the HTTP bitstream 200. In other embodiments, some or all of the remaining segments of image data are not automatically sent as a part of the HTTP bitstream 200, but instead are sent in response to a request for additional image data from the client device 110. FIG. 2 depicts an embodiment in which the segments are appended to the first portion 220. As shown in FIG. 2, the second level segments 206-2, 208-2, 210-2 are appended first, and so on, in series, until the n-th level segments 206-n, 208-n, 210-n. At the client device 110 as additional segments are received the image data within the segments is added to the initial data, which progressively increases the resolution or size of the image that can be reproduced at the client device 110. Once the client device 110 has received all the n segments for an image, it is capable of reproducing the full resolution image.

The progressive resolution encoding process may result in multiple “levels” of resolution. For example, in one embodiment, the encoding process at the server may result in four levels and the initial (lowest) level of resolution provides the image data required to produce a 1/64^{th} scale image. For example, if the original image was 800 pixels by 800 pixels, then the initial segment of image data would be sufficient to produce a 100 pixel by 100 pixel version of the image. The next level of resolution may be a 1/16^{th} scale image, meaning that the second segment of image data is the additional image data required to produce a 200 pixel by 200 pixel version of the image. The third level of resolution may be ¼ scale image, meaning that the third segment of image data, when added to the first two segments, is sufficient to create a 400 pixel by 400 pixel version of the image. The fourth and final segment of image data enables generation of the full 800 pixel by 800 pixel image. It will be appreciated that these precise scales of resolution are examples only.

In one example embodiment, the scaling of the image is based upon conversion of a conventional desktop screen width image of 1024 pixels to the screen width of a smaller handheld device screen of, say, 320 pixels. In other words, the lowest resolution level may be found by scaling down the image by 1024/320=3.2 in width and, similarly, 3.2 in height, for an overall scaled image of 1/10.24. In yet another example, with a handheld screen width of 240 pixels, the lowest resolution scaling of the image results in an image that is 1/18.2 the size of the original image. In yet another example, the scaling may take into account room for scroll bars or other borders of, say, five pixels on the handheld device screen, resulting in a scaling factor of 1024/(240−5)=4.3574 in one dimension, or an overall image scaling of about 1/19^{th}. Intermediate levels between full size/resolution and the smallest/lowest resolution may be selected to accommodate a range of applications.

In one embodiment, the resolution/scaling levels may be fixed and the server may apply the resolution/scaling process based on the fixed levels to each image. However, in some embodiments, the resolution/scaling levels may be determined dynamically based, for example, on the screen size of the requesting client device 110 (FIG. 1). The mobile data server 120 (FIG. 1) may receive information identifying the screen size, or the device type or another identifier from which it can determine the screen size. Based on the screen size, the mobile data server 120 may determine the appropriate scaling factors to use. In some instances, the screen size of the requesting client device 110 may be a factor in selecting from two or more sets of predefined resolution/scaling levels.

By scaling the images by a factor based on reduction from a conventional desktop display screen width (1024 pixels) to a handheld or mobile display screen width, the client device 110 may be provided with image data in the first portion 220 of the bitstream that is sufficient to display the full web page scaled down to the size of the display screen of the client device 110. In other words, the first portion 220 permits the client device 110 to render the web page in a fully “zoomed-out” state, where the full width of the web page is visible and its layout remains the same as it would look on a conventional desktop display.

Accordingly, the progressive resolution delivery of image data facilitates fast display of an initial “zoomed-out” rendering of a requested web page. In addition, the progressive resolution delivery of image data can be leveraged to implement multi-level zoom functionality within the browser.

As noted above in connection with FIG. 1, the client device 110 includes a zoom handler 160 that enables a user to zoom in (enlarge) a portion of a web page, or, when zoomed in, to zoom out to a broader view of the web page. The browser 140 provides a pointer or the like to enable a user to select zoom coordinates around which the zoom-in operation is to occur. In another embodiment, wherein the device 110 includes a touchscreen, the browser may receive zoom coordinates based on input from the touchscreen. The zoom coordinates selected by the user may, for example, define a center point of a zoom window within the current view of the web page that will then be enlarged and displayed on the screen. In some embodiments, the graphical interface may show the pointer as a moveable window or “zoom rectangle” indicating the size of the zoom window to the user.

The browser 140 and zoom handler 160 may permit multiple zoom levels. In one sense, the “zooming in” operation is realized by applying a lesser scaling factor to the web page. In other words, when rendering the web page on the screen, if rendered in 1:1 scale, i.e. no scaling, the web page would be fully “zoomed in”, and only a small portion of the overall page would be visible on a small display screen of, say, 240 pixels; whereas, if rendered in 1:20 scale (about 1:4.5 in width), the web page would be fully “zoomed out” and the entire width of the page would be visible, if the page were normally designed for a 1024 pixel width screen and rendered on a 240 pixel width screen. In between the fully “zoomed in” state and “zoomed out” state may be a multitude of “zoom” levels that reflect different scale factors applied to the web page.

The progressive resolution image data assists in realizing the zoom functionality by, first, providing a fully zoomed-out version of all images in the web page to enable quick rendering of the fully zoomed-out web page and, second, by subsequently supplying the additional data for rendering each of the images at varying levels of resolution/size. As the additional segments of image data arrive and enable progressively higher resolution images, the browser 140 is capable of further “zooming in” without requiring excessive interpolation to fill in missing image data.

The levels of progressive resolution of each image may be defined as:
1:1, 1:N₁², 1:N₂², 1:N₃², . . . , 1:Nₙ²

where Nᵢ is the image scaling factor in one dimension (e.g. width) and n is the number of resolution levels.

The levels of zoom available in the browser may be defined as:
1:1, 1:M₁², 1:M₂², 1:M₃², . . . , 1:Mₘ²

where Mᵢ is the image scaling factor in one dimension (e.g. width) and m is the number of zoom levels.

In many instances, it will be desirable to have Nᵢ<Mᵢ, so that the image being used at a given zoom level is of better resolution than is required for the scale of the web page at that zoom level, but it is not a necessary condition. If the currently available progressive resolution image data defines a smaller image than is required for a given zoom level, then the client device 110 may render the smaller image in a larger image space using interpolation techniques to scale the small image up to the image space. As additional segments of image data for that image arrive at the client device 110 to define a higher resolution (larger) image, the image may be repainted to reduce or eliminate the requirement to interpolate.

As noted above, in some embodiments the delivery of additional segments of image data may be automatic. For example, the server 120 may generate the HTTP bitstream 200 containing the appended additional progressive resolution image data segments and send the entire bitstream 200 so that the client device 110 will always be provided with a complete full resolution copy of each image in a web page.

In other embodiments, the delivery of additional segments may be wholly or partly “on-demand”. The server 120 may send only the first portion 200 of the HTTP bitstream 200 containing the initial segments of image data. Subsequent transmission of additional segments of data is dependent upon receiving a request from the client device 110 for further image data. The requests may be based upon whether the image data present on the client device 110 is of sufficient scale/resolution to satisfy the initial fully zoomed out view of the web page. For example, if the progressive resolution levels are 1/64^{th}, 1/16^{th}, ⅛^{th}, ¼, and 1, and the zoom levels begin at 1/19^{th}, then the initial image data at 1/64^{th} scale will be too small to use in the 1/19^{th} scale zoomed out web page without interpolation. Accordingly, the client device 110 may request the next segment of image data for each image. The 1/64^{th} scale images may be used initially with interpolation, then as the additional data is received to create 1/16^{th} scale images, the 1/16^{th} scale image data may be used, but scaled down to the 1/19^{th} scale size of the zoom level.

In another example, the on-demand request for additional segments of image data may be triggered by a change in the zoom level. If the browser 140 receives a zoom-in command, for example a transition from 1/19^{th} scale zoom to ⅛^{th} scale zoom, and the image data present on the device is of lower resolution than ⅛^{th} scale, then the browser 140 may send a request to the server 120 for additional image data. The device 110 may, in some embodiments, simply request the reminder of the data, may request the “next” set of image data segments, or may request data segments sufficient to achieve a given resolution/scale.

In yet another embodiment, the on-demand request may be specific to particular images. In such an embodiment, the browser 140 (in particular, the zoom handler 160) may identify the images that are visible in the zoom window defined by the zoom coordinates associated with the zoom command. Those images that are visible in the zoom window may be evaluated to determine whether sufficient resolution data is available on the device 110 and, if not, the request to the server 120 may identify the images for which additional progressive resolution data segments are required. The server 120 may send only data for those images specified in the request. In another embodiment, the device 110 may request, or the server 120 may calculate and preemptively send additional images that are predicted to be required soon based on panning or scrolling operations likely to be performed by the user at the next zoom level, thereby bringing other images into view on the screen and for which the higher resolution image data will thus be required. In some embodiments there may be no prediction, and all of the remaining images are requested by device 110 and/or preemptively sent by server 120.

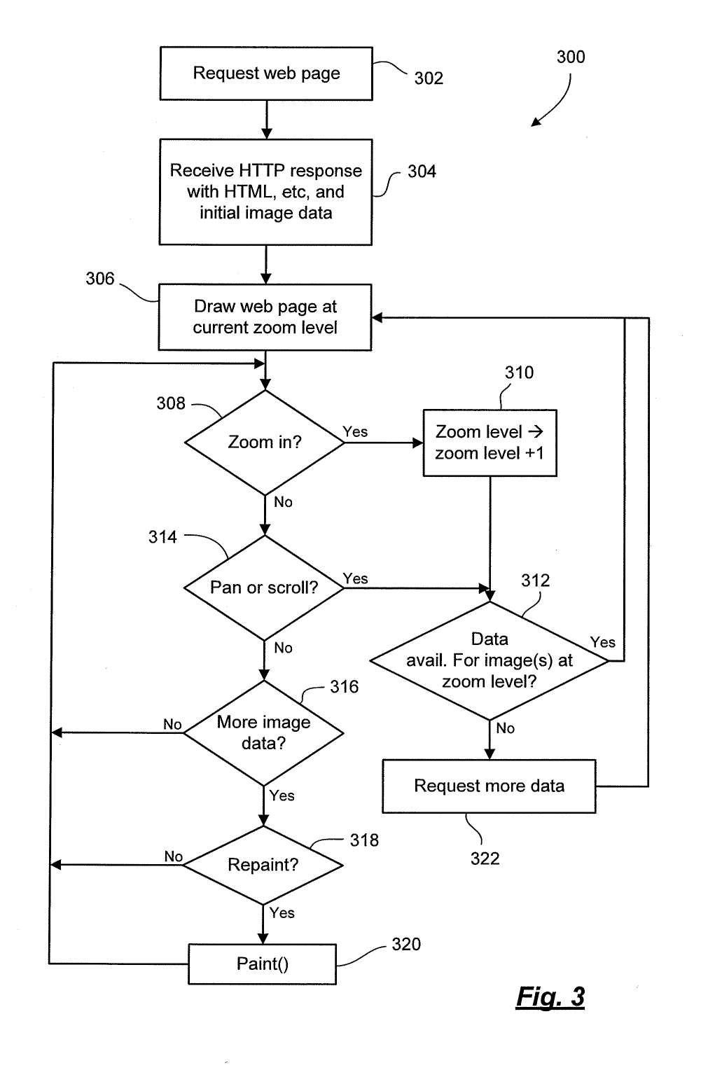

Reference is now made to FIG. 3, which shows, in flowchart form, an example method 300 of displaying multimedia data on a browser. For the purposes of this example method 300, it is presumed that the client device 110 (FIG. 1) is a mobile handheld device that has wireless connectivity with a public land mobile network (PLMN) or wireless local area network (WLAN) through which it communicates with the mobile data server 120 (FIG. 1). It is also presumed that no data for the requested web page is cached on the device 110 when the request is initiated. In the embodiment illustrated by the example method 300 described below it is presumed that progressive image data is transferred to the device up to a resolution sufficient to create the fully zoomed out web page view without interpolation. Depending on the resolution of the image data in the initial segment of progressive image data as compared to the scaling applied to create the zoomed out web page, additional image data may be required to achieve the image scale required by zoomed out view without requiring interpolation. This additional data may be sent automatically by the server 120 based on knowledge of the zoomed out scale used by the device 110, for example within the HTTP bitstream 200 (FIG. 2) appended to the first portion 220 (FIG. 2). Alternatively, the additional data may be requested by the device 110. In the example below, it is presumed that the server 120 sends the additional data automatically based on knowledge of the zoomed out scale used by the client device 110.

The method 300 begins in step 302 with transmission of a request for a web page, or other multimedia page, from the client device 110 to the mobile data server 120. In many embodiments, the request may be formatted as an HTTP request, such as a GET method, identifying the requested web page.

The mobile data server 120 retrieves the request web page, including image data. The image data may be in a variety of formats, including JPEG, GIF, PNG, etc. The mobile data server 120 converts each of the images in the web page into a progressive resolution image format, such as JPEG 2000. The conversion is based on a predetermined set of levels of resolution/scale. As noted above, in some embodiments the screen size of the client device 110 may be used to select an appropriate set of levels of resolution/scale. In some other embodiments, a hardcoded preconfigured set of resolution levels is used by the mobile data server 120. In addition to converting the images to a progressive resolution format, the mobile data server generates metadata regarding each of the images and, in particular, metadata particular to each of the “chunks” of image data at each resolution level.

The mobile data server 120 generates a response message, such as an HTTP response, for transmission to the client device 110. The HTTP response contains non-progressive data for the requested web page such as HTML, CSS, JavaScript, and other markup data. It also includes the lowest resolution image data for each image. As noted in connection with FIG. 2, for each image an initial segment is created and included in the first portion 220 (FIG. 2) of the HTTP response. The initial segment includes metadata for the image and the lowest resolution image data. It will be appreciated that in some embodiments the HTTP response may only include the first portion 220 and all subsequent portions of the progressive resolution image data may be sent “on-demand”.

Referring still to FIG. 3, at step 304 the client device 110 receives the HTTP response from the mobile data server 120. The HTTP response may be parsed by the browser 140 to extract the various portions of HTML, CSS, JavaScript, image data, etc. For each image in the web page, the browser 140 creates an image object containing the initially received lowest resolution image data. Once the browser 140 has received the first portion 220 of the HTTP response, then it has sufficient information to render a zoomed-out view of the web page.

A zoom level variable or parameter is initially set to level 0, or a “fully zoomed-out” status. The zoom level 0 reflects a minimum resolution rendering of the web page. Put another way, zoom level 0 indicates a maximum scaling down of the web page.

The client device 110, and in particular the browser 140 (FIG. 1), begins to process the received data from the HTTP response in step 306. For example, the layout engine 170 processes the non-progressive markup data to define bounding boxes for text or image spaces for graphical content. The layout engine 170 applies the scaling associated with the current zoom level in determining the layout of the various elements that make up the web page. The image decoder 180 processes each of the image objects to generate the image data for rendering each image in its defined image space. In some instances this may include scaling the image down to the image space size if the resolution of the image data in the image object is higher than that required for the image space. In some other instances this may include applying interpolation to scale up the image to the image space if the resolution of the image data in the image object is lower than that required for the image space. For example, if the initial low resolution image data defines an image at 1/64^{th} scale of the original and the zoomed out scale is 1/20^{th} of original, then the image data will need to be scaled up from its 1/64^{th} scale to a 1/20^{th} scale. As noted above, in the present example, the additional segments of image data necessary to create an image of at least 1/20^{th} scale may be appended to the first portion 220 of the HTTP response data by the mobile data server. The receipt and application of this additional data is described in subsequent steps explained below.

The renderer 190 draws the web page on the display 114 in its fully zoomed-out scale. Advantageously, this zoomed-out display of the web page can be created without requiring the download of all the image data for creating full scale images. It is also created using the very same HTML and non-progressive markup data that is required for rendering the web page in normal scale and using the initial portion of progressive image data, meaning that the zoomed-out display of the web page is quickly generated without increasing the overall quantity of data the client device receives.

Once the zoomed-out version of the web page is displayed, the user may manipulate an input device, such as a stylus, trackball, mouse, trackwheel, touch screen or the like, to control a pointer or zoom window on the display. In step 308, the browser 140 determines whether it has received a zoom-in instruction. The zoom-in instruction is associated with coordinates that define the window or area of the web page to which the zoom-in instruction applies. Note that the web page is not divided into predefined “sections” which the user can enlarge. Instead, the zoom handler 160 allows the user to define a window or area of the web page for enlargement. This window or area may include portions of text or images.

If a zoom-in instruction was not received in step 308, then in step 316 the browser 140 may determine whether additional image data has been received, for example as additional progressive “chunks” appended to the initial first portion 220 of the HTTP bitstream 200. The additional image data may alternatively have been received as part of a separate request-response, as will be outlined below. The additional image data is passed to its respective image object, which may be identified by the progressive resolution image handler 150 based on the metadata included with each segment of image data.

If additional image data has been received then in step 318 a determination may be made as to whether the image is to be repainted. The determination to repaint the images may depend on whether the images are currently rendered using interpolation because their previous resolution was insufficient for the scale of the zoom level. With additional image data, the images can be repainted, as indicated in step 320, to improve the resolution of the images displayed.

If a zoom-in instruction is received in step 308, then in step 310 the zoom level is increased by one. For example, in the fully zoomed out state of zoom level 0 a zoom-in instruction results in setting the zoom level to level 1. The scale associated with the various zoom levels may be preconfigured in the client device 110. For example, the fully zoomed out level 0 may be 1:16 scale and level 1 may be 1:8 scale. Other scales may be used in other embodiments.

After adjusting the zoom level in step 310, then in step 312 the client device 110 evaluates whether it has sufficient resolution image data for the scale of the new zoom level. For example, if the zoom level is associated with a scale of 1:8 then the browser 140 determines whether the image data available in the image objects is of at least a 1:8 resolution. In some embodiments, the evaluation in step 312 may be in relation to only those images that fall at least partly within the zoom window defined by the zoom instruction. In other embodiments, the evaluation may be made for all images in the page since the user may later pan or scroll within the zoom level to reveal other images. If the image data present on the device 110 is of sufficient resolution to realize the zoom level, then the method 300 returns to step 306 to draw the web page in accordance with the zoom level and zoom window coordinates.

If the resolution of the image data available on the device 110 is not sufficient, then the progressive resolution image handler 150 may send a request to the server 120 for additional image data, as indicated in step 322. In one embodiment, the request may specify the images identified in step 312 as falling within the zoom window, so that the server 120 only, or at least initially, sends the data relating to those images. In some embodiments, the server 120 may send the additional progressive resolution data for the identified images first and then preemptively send the additional progressive resolution data for other images since it may be required during pan or scroll operations. Determination of which images may be required could be done by either device 110 or server 120. The method 300 may return to step 306 to redraw the web page at the new zoom level. If further data has not yet been received in response to the request to the server 120, then the images may be rendered using the insufficient resolution data and interpolation. Then, as the additional data arrives, the images may be repainted, as described in connection with steps 316, 318, and 320.

In the course of displaying the web page at a given zoom level, the browser 140 may receive pan or scroll instructions from the user via the input device. As indicated in step 314, if the browser 140 detects a pan or scroll instruction, then the determination of step 312 may be made to identify whether images visible in the panned or scrolled view of the web page can be rendered at the current zoom level without requiring interpolation. If not, then a request may be made to the server 120 for such data, as in step 322.

After all the progressive resolution data for the images has been received, the image data is saved in the browser cache in memory. In some embodiments, individual segments of the image data may be saved to the browser cache as they are received, allowing future requests to occur only for the segments that have not been requested and/or received yet.

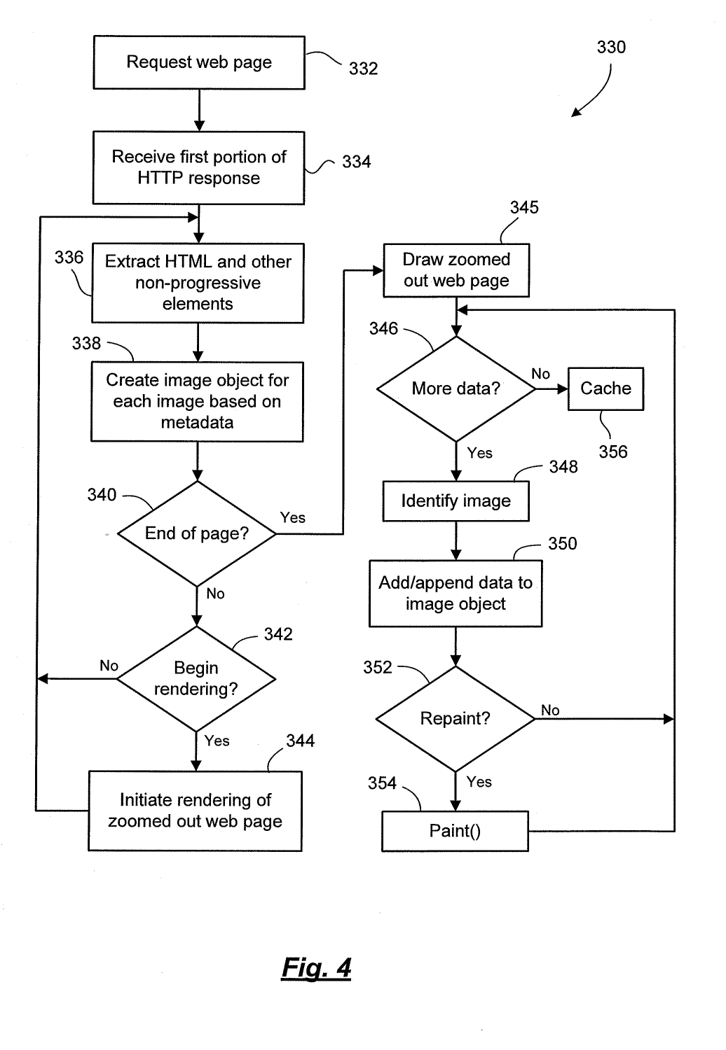

It will be appreciated that the above example method 300 presumes that the server 120 does not automatically send all the image data in its HTTP response bitstream, i.e. the sending of the subsequent progressive resolution segments is “on-demand”. In another example, the server 120 automatically forwards the subsequent segments within the HTTP bitstream. Reference is made to FIG. 4, which shows a second example method 330 of displaying multimedia data on a browser. In this second example method 330 the receipt of image data is not tied to zoom instructions. In some instances, the client device 110 may not yet have received the data required to satisfy a zoom instruction without requiring interpolation of image data. In those instances, the image is rendered using the available data and interpolation and is later re-painted at a higher resolution when the additional image data arrives.

Method 330 begins in step 332 with the transmission of the web page request to the server 120. The server 120 responds by sending the HTTP bitstream 200 containing the first portion 220 with non-progressive data, such as CSS, HTML, and JavaScript data, and initial segments of low resolution image data, as described above in connection with FIG. 2. Following the first portion 220, the HTTP bitstream 200 contains all the remaining segments of image data, grouped by resolution level.

In step 334 the client device 110 begins receiving the HTTP bitstream 200. The browser 140 parses the received bitstream and extracts the non-progressive data, such as HTML, as indicated in step 336. In step 338 any image data received is extracted from the HTTP bitstream. In particular, the progressive resolution image handler 150 receives the initial low resolution segments of image data, including metadata for each image. Based on the metadata, the progressive resolution image handler 150 creates an image object for each image and populates the object with the low resolution image data.

In step 340, the browser 110 determines whether it has received all the elements of the page. In other words it determines whether it has received the entire first portion 220 of the HTTP bitstream 200. If not, then it determines whether it may nevertheless begin rendering the web page based on the elements and data that it does have. In some instances, the browser 140 may be permitted to begin laying out the web page, defining image spaces, etc., despite the fact not all data for the web page has been received. If the browser 140 is permitted to begin layout and rendering operations, then the method 330 continues to step 344 where the layout engine 170 and renderer 190 may begin processing data for output to the display 114. As described in connection with FIG. 3, the layout and rendering of the web page is based on a scaling factor associated with the initial fully zoomed-out state of the web page.

Following steps 342 or 344, the method 300 returns to step 336 to receive additional data in the first portion 220. Once the full first portion 220 is received, as determined in step 340, then the web page is rendered in fully zoomed-out scale, as indicated by step 345. If this process has already been initiated in step 344 then it continues until the page is fully output to the display 114.

In the meantime, the browser 140 continues to receive the HTTP bitstream 200 and, in particular, additional segments of progressive resolution image data. As indicated in step 346, the browser 140 evaluates whether the incoming HTTP bitstream 200 contains additional segments of progressive resolution image data. If so, then in step 348 it identifies, based on the metadata in the segment, to which image the data relates. It then adds or appends the received image data to the identified image object, as indicated in step 350.

Having received additional image data, the image might then be repainted. As indicated in step 352, a determination may be made as to whether it is necessary or desirable to repaint the image. This determination may be made based on whether the image (a) currently appears on the display and (b) was rendered using interpolation because the image data available earlier was of insufficient resolution. If repainting is appropriate, then in step 354 the paint( ) operation is called, with the scaling appropriate to the current zoom level. In another embodiment, the image is instructed to repaint itself every time that additional image data is received. If the data is not need to improve the image rendered on the display, then there will be no visible effect.

If, in step 346, there is no further image data to come, then the image data in the image objects may be written to the browser cache, as indicated in step 356. In a different embodiment, caching of individual segments may occur as they are received (step 350) instead of just once at step 356. This would allow future requests to exclude the segments that are already cached.

Those skilled in the art will understand from the above description that certain steps in the described methods may be performed in a different sequence or concurrently without materially affecting operation of the method. Similarly, additional steps may be performed and certain steps may be modified or eliminated without materially affecting operation of the method.

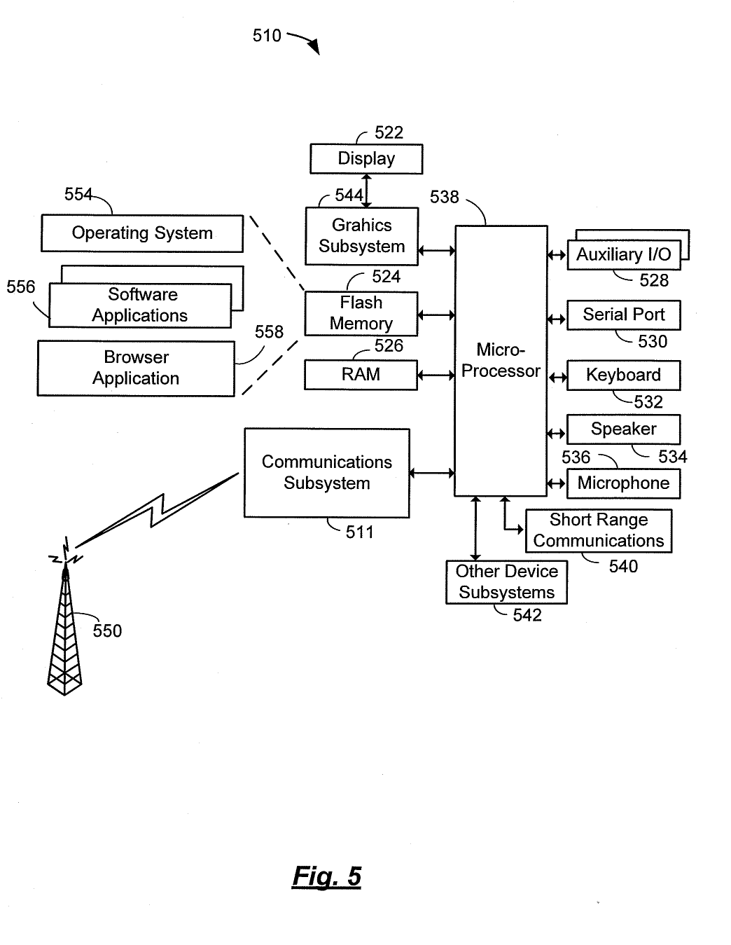

Reference is now made to FIG. 5, which shows a block diagram of an example embodiment of a client device 510. In the example embodiment, the client device is a two-way mobile communication device 510 having data and possibly also voice communication capabilities. In an example embodiment, the device 510 has the capability to communicate with other computer systems on the Internet. Depending on the functionality provided by the device 510, in various embodiments the device may be a data communication device, a multiple-mode communication device configured for both data and voice communication, a mobile telephone, a PDA enabled for wireless communication, or a computer system with a wireless modem, among other things.

In this embodiment, the device 510 includes a communication subsystem 511, including a receiver, a transmitter, and associated components such as one or more, preferably embedded or internal, antenna elements, and a processing module such as a digital signal processor (DSP). In some embodiments, the communication subsystem includes local oscillator(s), and in some embodiments the communication subsystem 511 and a microprocessor 38 share an oscillator. As will be apparent to those skilled in the field of communications, the particular design of the communication subsystem 511 will be dependent upon the communication network in which the device 510 is intended to operate.

Signals received by the antenna through a wireless network 550 are input to the receiver, which may perform such common receiver functions as signal amplification, frequency down conversion, filtering, channel selection and the like, and in some embodiments, analog to digital conversion. In a similar manner, signals to be transmitted are processed, including modulation and encoding for example, by the DSP and input to the transmitter for digital to analog conversion, frequency up conversion, filtering, amplification and transmission over the wireless network 550 via the antenna 518.

The device 510 includes a microprocessor 538 that controls the overall operation of the device. The microprocessor 538 interacts with communication subsystem 511 and also interacts with further device subsystems such as the graphics subsystem 544, flash memory 524, random access memory (RAM) 526, auxiliary input/output (I/O) subsystems 528, serial port 530, keyboard or keypad 532, speaker 534, microphone 536, a short-range communications subsystem 540, and any other device subsystems generally designated as 542. The graphics subsystem 544 interacts with the display 522 and renders graphics or text upon the display 522.

Operating system software 554 and various software applications 556 used by the microprocessor 538 are, in one example embodiment, stored in a persistent store such as flash memory 524 or similar storage element. One software application 556 may be a browser application 558. Those skilled in the art will appreciate that the operating system 554, the software applications 556, such as browser application 558, or parts thereof, may be temporarily loaded into a volatile store such as RAM 526. It is contemplated that received communication signals may also be stored to RAM 526.

The microprocessor 538, in addition to its operating system functions, preferably enables execution of software applications on the device. A predetermined set of software applications which control basic device operations, including at least data and voice communication applications for example, will normally be installed on the device 510 during manufacture. Further software applications may also be loaded onto the device 510 through the network 550, an auxiliary I/O subsystem 528, serial port 530, short-range communications subsystem 540 or any other suitable subsystem 542, and installed by a user in the RAM 526 or a non-volatile store for execution by the microprocessor 538. Such flexibility in application installation increases the functionality of the device and may provide enhanced on-device functions, communication-related functions, or both. For example, secure communication applications may enable electronic commerce functions and other such financial transactions to be performed using the device 510.

In a data communication mode, a received signal such as a text message or web page download will be processed by the communication subsystem 511 and input to the microprocessor 538, which will preferably further process the received signal for output to the display 522 through the graphics subsystem 544, or alternatively to an auxiliary I/O device 528. It is contemplated that the auxiliary I/O device includes an image rendering subsystem like the graphics subsystem 544 for rendering graphics and text upon the auxiliary I/O device 528. For example, a printer includes an image rendering subsystem for receiving and rendering image data. A user of device 510 may also compose data items within a software application, such as email messages for example, using the keyboard 532 in conjunction with the display 522 and possibly an auxiliary I/O device 528. Such composed items may then be transmitted over a communication network through the communication subsystem 511.

The serial port 530 would normally be implemented in a personal digital assistant (PDA)-type communication device for which synchronization with a user's desktop computer (not shown) may be desirable, but is an optional device component. Such a port 530 would enable a user to set preferences through an external device or software application and would extend the capabilities of the device by providing for information or software downloads to the device 510 other than through a wireless communication network.

A short-range communications subsystem 540 is a further component which may provide for communication between the device 510 and different systems or devices, which need not necessarily be similar devices. For example, the subsystem 540 may include an infrared device and associated circuits and components or a Bluetooth™ communication module to provide for communication with similarly enabled systems and devices. The device 510 may be a handheld device.

Wireless network 550 is, in an example embodiment, a wireless packet data network, (e.g. Mobitex™ or DataTAC™), which provides radio coverage to mobile devices 510. Wireless network 50 may also be a voice and data network such as GSM (Global System for Mobile Communication) and GPRS (General Packet Radio System), CDMA (Code Division Multiple Access), or various other third generation networks such as EDGE (Enhanced Data rates for GSM Evolution) or UMTS (Universal Mobile Telecommunications Systems).

Certain adaptations and modifications of the described embodiments can be made. Therefore, the above discussed embodiments are considered to be illustrative and not restrictive.

What is claimed is:

1. A method of performing zoom operations in a browser application on a client device, wherein the client device is configured to request a web page from a data server, and wherein the data server obtains the web page and converts images within the web page to a progressive format, the browser application being configured to offer at least three zoom levels, and wherein the at least three zoom levels include a fully zoomed-out level and an intermediate level, the method comprising:
receiving a first portion of a response message from the server containing non-progressive data including mark-up language data and containing initial low resolution image data for each of the images;
rendering the web page at the fully zoomed-out level by applying a maximum scaling factor to the web page and using the non-progressive data and the initial low resolution image data to render the web page;
receiving a zoom command, wherein the zoom command defines a zoom window within the web page, the zoom window containing at least a portion of at least one image;
receiving additional progressive resolution image data for the at least one image from the server after the first portion; and
rendering the web page at the intermediate level by applying a intermediate scaling factor to the web page and using the non-progressive data and the combination of the initial low resolution image data and the additional progressive resolution image data,
wherein the step of rendering the web page at the fully zoomed-out level is initiated before receiving additional progressive resolution image data.

2. The method claimed in claim 1, wherein the step of receiving additional progressive resolution image data is not conditional on receiving the zoom command.

3. The method claimed in claim 2, wherein the response message comprises an HTTP bitstream, and wherein the first portion includes at least one HTML element for the webpage and the initial low resolution image data, and wherein the HTTP bitstream includes a second portion containing the additional progressive resolution image data.

4. The method claimed in claim 3, wherein the HTTP bitstream includes at least one further portion containing further progressive resolution image data.

5. The method claimed in claim 2, wherein the step of receiving the first portion includes defining and storing an image object for each of the images, each image object containing the initial low resolution image data for its image, and wherein the step of receiving additional progressive resolution image data include adding the additional progressive resolution image data to the corresponding image object, thereby producing an image object containing higher resolution image data.

6. The method claimed in claim 5, wherein the maximum scaling factor specifies higher resolution images than the resolution of the initial low resolution image data, and the step of rendering the web page at the fully zoomed-out level includes interpolating the initial low resolution image data, and wherein the step of receiving the additional progressive resolution image data triggers a repainting of the images at the maximum scaling factor resolution prior to receiving the zoom command.

7. The method claimed in claim 1, wherein receiving the zoom command triggers causes a request for additional data to be sent to the data server, and wherein the step of receiving additional progressive resolution image data is in response to the request for additional data.

8. The method claimed in claim 7, wherein the step of sending the request for additional data includes identifying images at least partly visible within the zoom window, wherein the request for additional data specifies those identified images, and wherein the additional progressive resolution image data excludes data for images not specified in the request.

9. The method claimed in claim 1, wherein the combination of the initial low resolution image data and the additional progressive resolution image data produces intermediate resolution image data, and wherein the intermediate scaling factor specifies higher resolution images than the resolution of the intermediate resolution image data, and the step of rendering the web page at the intermediate level includes interpolating the intermediate resolution image data, and wherein a further step of receiving further progressive resolution image data triggers a repainting of the images at the intermediate scaling factor resolution.

10. The method claimed in claim 1, wherein the client device comprises a mobile device configured to communicate with the data server via a wireless communications network.

11. A mobile device configured for wireless communications with a wireless network, wherein the wireless network is connected to a data server configured to obtain a web page and to convert images within the web page to a progressive format, the mobile device comprising:
a display screen;
a communications subsystem for sending and receiving messages over a wireless link to the wireless network;
a memory;
a processor configured to control the communications subsystem and the display screen;
a browser application configured to offer at least three zoom levels in display of the web page on the display screen, and wherein the at least three zoom levels include a fully zoomed-out level and an intermediate level;
a zoom handler configured to receive a zoom command, wherein the zoom command defines a zoom window within the web page, the zoom window containing at least a portion of at least one image; and
a progressive resolution image handler configured to receive a first portion of a response message from the data server containing non-progressive data including mark-up language data and containing initial low resolution image data for each of the images, and to receive additional progressive resolution image data for the at least one image from the data server after the first portion,
wherein the browser application is configured to render the web page at the fully zoomed-out level, before receiving additional progressive resolution image data, by applying a maximum scaling factor to the web page and using the non-progressive data and the initial low resolution image data to render the web page, and wherein the browser application is configured to render the web page at the intermediate level by applying a intermediate scaling factor to the web page and using the non-progressive data and the combination of the initial low resolution image data and the additional progressive resolution image data.

12. The mobile device claimed in claim 11, wherein the additional progressive resolution image data is received by progressive resolution image handler irrespective of whether the zoom handler receives a zoom command.

13. The mobile device claimed in claim 12, wherein the response message comprises an HTTP bitstream, and wherein the first portion includes at least one HTML element for the webpage and the initial low resolution image data, and wherein the HTTP bitstream includes a second portion containing the additional progressive resolution image data.

14. The mobile device claimed in claim 13, wherein the HTTP bitstream includes at least one further portion containing further progressive resolution image data.

15. The mobile device claimed in claim 12, wherein the progressive resolution image handler is configured to create an image object in memory for each of the images and store the initial low resolution image data for each image in its image object, and wherein progressive resolution image handler is configured to add the additional progressive resolution image data to the corresponding image object, thereby producing an image object containing higher resolution image data.

16. The mobile device claimed in claim 15, wherein the maximum scaling factor specifies higher resolution images than the resolution of the initial low resolution image data, and the browser application is configured to interpolate the initial low resolution image data when rendering the web page at the fully zoomed-out level, and to repaint the images at the maximum scaling factor resolution on receipt of the additional progressive resolution image data.

17. The mobile device claimed in claim 11, wherein the zoom handler is configured to cause a request for additional data to be sent to the data server in response to receipt of the zoom command, and wherein the additional progressive resolution image data is received in response to the request for additional data.

18. The mobile device claimed in claim 17, wherein the request for additional data identifies images at least partly visible within the zoom window, and wherein the additional progressive resolution image data excludes data for images not identified in the request.

19. The mobile device claimed in claim 11, wherein the combination of the initial low resolution image data and the additional progressive resolution image data produces intermediate resolution image data, and wherein the intermediate scaling factor specifies higher resolution images than the resolution of the intermediate resolution image data, and the browser application is configured to interpolate the intermediate resolution image data when rendering the web page at the intermediate level, and wherein the browser application is configured to repaint the images on receipt of further progressive resolution image data.

20. A client device configured for communications with a network, wherein the network is connected to a data server configured to obtain a web page and to convert images within the web page to a progressive format, the client device comprising:
display means for displaying the web page;
communications means for sending and receiving messages over the network;
memory means for storing data;
processing means for controlling the communications means and the display means;
browser means for offering at least three zoom levels in display of the web page on the display means, and wherein the at least three zoom levels include a fully zoomed-out level and an intermediate level;
zoom means configured to receive a zoom command, wherein the zoom command defines a zoom window within the web page, the zoom window containing at least a portion of at least one image;
image handling means for receiving a first portion of a response message from the data server containing non-progressive data including mark-up language data and containing initial low resolution image data for each of the images, and for receiving additional progressive resolution image data for the at least one image from the data server after the first portion;
means for rendering the web page at the fully zoomed-out level, before receiving additional progressive resolution image data, by applying a maximum scaling factor to the web page and using the non-progressive data and the initial low resolution image data to render the web page; and
means for rendering the web page at the intermediate level by applying a intermediate scaling factor to the web page and using the non-progressive data and the combination of the initial low resolution image data and the additional progressive resolution image data.
